(19) United States
(12) Patent Application Publication
(10) Pub. No.: US 2014/0010932 A1
(43) Pub. Date: Jan. 9, 2014

(54) High pressure pasteurization of fresh sausage and fresh meat emulsion and avoiding the loss of color and taste in the process

(71) Applicant: Walter Freybe, Abbotsford (CA)

(72) Inventor: Walter Freybe, Abbotsford (CA)

(21) Appl. No.: 13/541,542

(22) Filed: Jul. 3, 2012

(51) Int. Cl. A23L 1/317; A23B 4/00; A23L 1/272

(52) U.S. Cl. 426/262; 426/641; 426/392

(57) ABSTRACT

A process of preserving fresh sausages or fresh meat emulsions with high pressure and avoiding color fading and diminishing of taste comprises the steps of a) packing the products into sealed packages, b) Putting the packages into a pressurization vessel, increasing pressure in the vessel up to 100.000 PSI that the packages are exposed to the elevated pressure. c) Maintaining pressure for a time up to 300 seconds, at a temperature up to 45 F, d) removing the packages with fresh meat products from the pressure vessel. Pathogens are killed during this process providing a longer shelf life while retaining taste, color compared to having fresh meat products that are packed without the benefit of high pressure. To avoid color fading and loss of flavor during this process, spices which are not part of the original and historical recipe are used to compensate.

This invention relates to the high pressure pasteurization of fresh sausages and fresh spiced meat emulsions and avoiding color fading and loss of taste during this process. Fresh spiced meat emulsions would mean to be either sausage or meat loaf emulsions.

The meat used for the production of fresh sausages and fresh, spiced meat emulsions is ground to the specifications of the recipe. It is then mixed with the appropriate spices and water.

In order to prevent fading of color during the high pressure pasteurization process, spices or curing aids which are not part of the original recipe are added. In order to prevent the loss of taste during the high pressure pasteurization process an additional percentage of spices of the original recipe is added to the mix. This percentage might need an additional of spices up to 50% of the original recipe.

The fresh sausages or fresh, spiced meat emulsions are then packed into sealed packages.

The sealed packages are then put into a pressurization vessel. The vessel is closed, water is added to the vessel and the pressure increased to a range of 60.000 PSI up to 100.000 PSI. As a result the packages are exposed to the elevated pressure.

The pressure is maintained for a time up to 300 seconds at a temperature from 32 F up to 45 F.

Releasing the pressure in the vessel to ambient pressure and remove the packages from the vessel.

The high pressure pasteurization process has killed all pathogens in the fresh sausage and fresh spiced meat emulsions.

The fresh sausage and fresh, spiced meat emulsions which have been pasteurized by high pressure can now be shipped or kept refrigerated for a period of up to 60 days and perhaps 120 days, thus avoiding the need for the product to be frozen for a longer shelf life than it is normal for these fresh products.

### Examination Support Documents

### Reference Cited

U.S. Patents:

| | | |
|---|---|---|
| 5213029 | Yukata | May 1993 |
| 5316745 | Ting | May 1994 |
| 6033701 | Hirsch | March 2000 |
| 6207215 | Wilson | March 2001 |
| 6440484 | Tanaka | August 2002 |

Foreign Patent Documents

| 2006/097248 A1 | WO | September 2006 |
|---|---|---|
| 2011/038237 | WO | March 2011 |

### Other References

Anath, V Shelf life extension, safety and quality of fresh pork loin treated with high hydrostatic pressure. Journal of Food protection; Volume 61,No 12;December 1998; pages 1649-1656
Murano Application of high hydrostatic pressure to eliminate listeria, and monocytogenes from fresh pork sausage; Journal of Food protection; May 1999; Volume 62/5 pages 480-483
Balasubramaniam, V. M. high Pressure Food preservation; Encyclopidia of Agriculture and Biological Engineering; September 2003; DOI:10.1081/e-eate-12007111
Jung, S. Influence of high pressure on the color and microbial quality of beef meat; Lebensmittel-Wissenschaft and Technologie; September 2003; Volume 36; issue 6; pages 625-631
Garriga, M. Microbial inactivation after high pressure processing at 600 Mpa in commercial meat products over its shelf life.
Innovating Food Science & Emerging Technologies; December 2004; Volume 5; Issue 4; Pages 451-457.

### FIELD

This invention relates to the preservation of fresh sausages and fresh meat emulsions by using ultra high pressure preservation.

### BACKGROUND OF THE INVENTION

Fresh sausages and fresh meat emulsions are distributed and sold either fresh or frozen. Consumers perceived “fresh” to be of better value partly because of faster cooking times from fresh (32-39 F) instead frozen (normally 0-32 F). There is a much reduced shelf life by distributing fresh sausage and fresh meat emulsions (generally up to 10 days) while a frozen fresh sausage and frozen fresh meat emulsion would have a shelf life up to 180 days.

Fresh sausage and fresh meat emulsions can also be contaminated with listeria, e-coli, salmonella or other pathogens which would create an additional risk if the product is not properly cooked or fried before consumption.

Fresh sausage and fresh meat emulsions processed with high pressure preservation are known to loose original color and may loose some of its original taste. This invention would overcome such drawbacks by adding curing aids and spices not normally used in the original recipe to compensate for the loss of color and by overcoming the loss of flavor by adding up to 60% more of the spices specified by the original recipe or as specified for regular use by a spice company providing such spice mixes.

U.S. Pat. No. 6,033,701 describes the sterilization of fruits. High pressure has also been used in the preservation or other treatment in fish products as described in the U.S. Pat. No. 6,440,484.

U.S. Pat. No. 5,593,714 describes a high pressure treatment Using a pressure of 25.000 PSI at 18-23 C for 5 days for Fruits, vegetables, meats and dairy products and incorporating a marinade into the products before high pressure treatment. U.S. Pat. No. 6,033,701 describes a high pressure treatment using a pressure of 10.000 PSI for 12 hours for fruits and vegetables and requires meat and seafood to be marinated before treatment.

The leading supplier of production scale equipment for ultra High Pressure Processing (HPP) is NC Hyperbaric from Burgos, Spain. NC holds several patents relative to the engineering and materials and methods of construction of this equipment. However it is important to note that they are not a food producer, they are a machinery supplier.

http://www.nchyperbaric.com

Millard Refrigerated Services is an example of a HPP service supplier. They own equipment produced by NC Hyperbaric placed at several locations in North America and sell processing through their machines to various food manufacturers that do not own their own equipment. Millard lists the typical applications for HPP as:
Prepared foods
Sausages
Juices
Dairy Products
Dips
Salsa
Seafood
Salads
Salad Dressings

http://www.millardref.com/HPP

HPP treatment is specific to each product and procedures have to be developed for each product to have the desired effect.

Extensive Microbial test were conducted over a 52 day period which showed total plate counts of less than 100 CFU.

### SUMMARY OF INVENTION

The present process consists of packaging fresh sausages and fresh meat emulsions in sealed packages. These packages are then placed in to a pressure vessel. The vessel and as a result the packages with fresh sausages or fresh meat emulsions are pressurized to an elevated pressure of at least 60.000 psi up to 100.000 PSI for a time from about 1 to 300 seconds and at a temperature from about 32 F to 40 F during this pasteurization process. The pressure in the vessel and as a result in the packages with fresh sausage and fresh meat emulsions is then reduced to ambient pressure and the packages are removed from the vessel.

The present invention lengthens the time the fresh sausage and fresh meat emulsions are of high quality compared to the normal processing of such products. Subjecting the fresh sausage and fresh meat emulsions to ultra high pressure processing will efficiently kill or render harmless any pathogens in the sausage without the use of preservatives other than salt.

It has been established that the pressure used in this process is very effective in killing pathogens in the fresh sausage and fresh meat emulsions in a very short time. In conjunction with high pressure processing equipment the pathogen killing step can be carried out in a time of less than 300 seconds and preferably in a time frame of between 120 seconds and 180 seconds while maintaining a temperature which will not rise above 40 F. This process will allow the manufacturer to follow the HACCP principles. The main advantages for the producers are a product clean of pathogens and as a result a longer shelf life. For the consumer there is an added advantage that because of the zero microbial counts in the sealed package the time frame in which consumption has to follow opening the package will likely be extended by several days as long as the product is properly refrigerated. Fresh sausage and fresh meat emulsion produced, packed and sold in the normal manner has a typical shelf life of 10 days whereas the fresh sausage and fresh meat emulsion packed in a sealed package and processed with ultra high pressure has a shelf life of 60 days and potentially 120 days.

### DETAILED DESCRIPTION OF PRESENTLY PREFERRED REPRESENTATION

The representation of the present invention as described are not to limit the invention to the exact details of the description. The purpose of the representation is to describe to others the principles of the invention.

The normal process of subjecting the vessel and as a result the sealed packages of fresh sausage and fresh meat emulsion to ultra high pressure is by placing the packages into cartridges. These cartridges are then placed into the pressure vessel. The vessel is then closed and water is added to fill the vessel and as a result submerge all sealed packages in water. The vessel is then closed and additional water is added to create the desired pressure. The fresh sausage and fresh meat emulsion packaged in sealed packages is the subjected to a minimum pressure of 60.000 PSI to a maximum of 100.000 PSI for a time from 1 to 300 seconds of more preferably from 120 to 180 seconds.

The meat used in the fresh sausage and fresh meat emulsion may be comprised of: fresh pork, beef, lamb, turkey, chicken, or a combination thereof.

The meat for the sausage is ground into particles according to requirement. The process and results can be enhanced by adding spices or curing aids not normally part of the original recipe are added to retain color. Spices normally used in a particular recipe or the percentage usually specified by a spice company providing such spice mixes may have to be increased by as much as 60% of normal requirement to retain the desired flavor. The ground meat and spices are then mixed and blended for uniformity, stuffed into casings and divided into appropriate length of sausages or in case of fresh meat emulsions are stuffed into plastic bags with the desired weight.

Depending on the length of the sausages and the diameter of the casings the individual sausage may weigh from 1 to 16 ounces each. The sausages are then packed according to customer demand into sealed packages for the particular market weighing a total of 2 ounces to 96 ounces per sealed package or in the case of fresh meat emulsion the plastic bags are filled to customer demand.

The package is an airtight package which might be subjected to a vacuum or the package might have a head space which may or may not have an oxygen replacement in the form of a: gas comprised carbon dioxide, nitrogen, carbon-monoxide, nitrous-oxide, hydrogen, neon, argon, krypton, xenon or mixtures thereof.

What is claimed is:

1) A process of preserving fresh sausage or fresh, spiced meat emulsions by high pressure pasteurization.
a) Packaging the fresh sausage or fresh, spiced meat emulsions in to sealed packages.
b) Putting the sealed packages into a pressurization vessel.
c) Closing the vessel and pressurizing the vessel containing the packages of fresh sausages or fresh, spiced meat emulsions to an elevated pressure of at least 60.000 PSI up to 100.000 PSI resulting in exposing the packages of fresh sausage or fresh, spiced meat emulsions to the same pressure.
d) Maintaining the elevated pressure on the packaged fresh sausage or fresh, spiced meat emulsions for a time from about 1 to 300 seconds and at a temperature from 32 F to about 45 F.
c) Reducing the pressure of the vessel and as a result on the packaged fresh sausage or fresh, spiced meat emulsions to ambient pressure.

2) A process to avoid fading of color and loss of flavor of the fresh sausage and fresh, spiced meat emulsions during the high pressure pasteurization process.
a) By adding different spices or curing aids to the mix which are not part of the original recipe to avoid the fading of color during the high pressure pasteurization process when mixing the fresh sausage or fresh, spiced meat emulsion.
b) Increasing the percentage of spices from the original recipe, or from a percentage normally specified by spice companies providing such spice mixes, by up to 60% to overcome the loss of flavor caused by the high pressure pasteurization process.
c) Packaging the fresh sausage or fresh, spiced meat emulsions in sealed packages and processing the sealed packages with high pressure pasteurization.

3) The claim is that the sealed packages of fresh sausage and fresh, spiced meat emulsions which have been processed with high pressure pasteurization do not have to be frozen for a period for up to 60 days and possibly up to 120 days but can be refrigerated for this period of time thus avoiding the need to store or ship the fresh sausage and fresh meat emulsions in a frozen state.
